(19) United States
(12) Patent Application Publication
(10) Pub. No.: US 2007/0205912 A1
(43) Pub. Date: Sep. 6, 2007

(54) Dedicated remote control

(75) Inventors: Jonathan Lane, Norwood, NJ (US); Kenneth Gassman, Woodmere, NY (US); Alan Iny, Fort Lee, NJ (US); William Lane, New York, NY (US)

Correspondence Address: KAPLAN GILMAN GIBSON & DERNIER L.L.P., 900 ROUTE 9 NORTH, WOODBRIDGE, NJ, 07095, US

(73) Assignee: Star Light Electronics, L.L.C.

(21) Appl. No.: 11/367,900

(22) Filed: Mar. 3, 2006

(51) Int. Cl. G08C 19/00

(52) U.S. Cl. 340/825.72; 341/176; 348/734; 340/825.22

(57) ABSTRACT

Provided are a device, system, method and software for remote controlling substantially all models and all features of a given manufacturer's media device, such as televisions. Included are a handheld case having a communication interface through which control instructions are issued to a control signal generating component, which includes a processor operatively connected to a computer memory and a remote control signal transmitter, being configured for performing the steps of converting the control instructions received from the communications interface into one or more remote control signals, and directing the remote control signal transmitter to transmit the one or more remote control signals at a pre-selected frequency, which substantially all models of the given manufacturer's media device responds to.

### BACKGROUND OF THE INVENTION

Television remote controls have been in use for many years. Typically, when television manufacturers produce a television set, they place into the television set the requisite device or circuitry and receiver, operating at a predetermined frequency, to accept command input from a remote control device, which is often included with the television when it is sold to a user.

In a majority of instances, a given manufacturer uses the same or similar device or circuitry for responding to remote control signals, operating at the same predetermined frequency, in all or substantially all models of their televisions. However, many operational keys are often linked together differently by the manufacturer, which is critical for proper operation of the feature. Many times a manufacturer will use one system of operation for a particular function on certain televisions, and another system of operation for that same feature on other televisions.

Another common trend is that through overuse, accident and mistake, users often either misplace their television remote control, or it stops functioning, such as through breakage.

There have been many attempts to provide users with so-called “universal remotes.” Universal remotes are remotes that are advertised to work with any television, and many generally require a learning mode; where the user essentially programs the universal remote to work with the user's television.

Universal remotes have several negative features.

First, being designed as a broad-coverage device that works with essentially any television, universal remotes normally offer a simplified command set, thereby not normally providing a user interface featuring the full command set for each individual television or television manufacturer. For example, while some manufacturers' televisions provide a PIP (“picture-in-picture”) capability, supported by the remote control that comes with the television, many universal remotes do not provide a user interface or command set to support such a PIP function. Moreover, even when supported, the feature keys need to be linked like on the original manufacturer's remote control or it will not operate correctly.

It is thus desirable to provide a remote control that features the full command set available for a given manufacturer's televisions.

Second, a universal remote, as mentioned above, normally must be programmed by the user. This programming is often a time-consuming operation, and one which does not always stay programmed in the remote; i.e., often such a universal remote requires multiple efforts of programming because it loses the programming.

It is thus also desirable to provide a remote control that does not require such programming by the user in order for it to work with a given manufacturer's televisions.

### SUMMARY OF THE INVENTION

One aspect of the present invention provides a remote control device for use with substantially all models of a manufacturer's television sets or other media devices. The remote control device includes a handheld case having a communication interface through which control instructions are issued to a control signal generating component. The control signal generating component includes a processor operatively connected to a computer memory and a remote control signal transmitter. The processor and memory are configured for performing the steps of converting the control instructions received from the communications interface into one or more remote control signals, and directing the remote control signal transmitter to transmit the one or more remote control signals at a pre-selected frequency. The pre-selected frequency and one or more remote control signals are selected to correspond to the frequency and remote control signals which substantially all models of the given manufacturer's televisions or other media devices respond to. The response is for the television to perform the operations input through the control interface.

In an aspect of the invention, the media device is a television.

In another aspect of the invention, the media device is a game console, or VCR, or CD player, or DVD player, etc.

Another aspect of the invention provides a system for remotely controlling substantially all models of a given manufacturer's electronic device. The system includes an electronic device to be remotely controlled, having a receiver for receiving one or more transmitted remote control signals. The device is further configured to be controlled based on the received remote control signals. The system also includes a handheld remote control unit, comprising a processor operatively connected to a memory, a command input interface, and a transmitter capable of transmitting at a pre-selected communication frequency. The processor and memory are configured for accepting an input from the command input interface, converting the input into one or more remote control instructions for the electronic device, and transmitting by the transmitter the one or more remote control instructions at the communication frequency. The pre-selected communication frequency and one or more remote control instructions are pre-selected to work for all models of a given manufacturer's electronic device.

In an aspect of the invention, the electronic device is a television.

In another aspect of the invention, the electronic device is a game console, or VCR, or CD player, or DVD player, etc.

Another aspect of the invention provides a method of remotely controlling substantially all models of a given manufacturer's television sets. The method includes determining a communication frequency and a set of remote control signals to which substantially all of the given manufacturer's television sets respond to remotely, providing a processor operatively connected to a memory, an input device and a transmitter capable of transmitting at the communication frequency. The processor and memory are configured to run a computer software for accepting an input from the input device, converting the input into one or more remote control instructions for a television, and transmitting by the transmitter the one or more remote control instructions at the communication frequency.

### BRIEF DESCRIPTION OF THE DRAWINGS

FIG. 1 is an illustration of an exemplary remote control in accordance with an embodiment of the present invention;

FIG. 2 is an illustration of an exemplary remote control in accordance with an embodiment of the present invention;

FIG. 3 is an illustration of an exemplary remote control for an electronic game system in accordance with an embodiment of the present invention;

FIG. 4 is a listing of the transmitter signal code, frequency and timing of an exemplary dedicated remote control in accordance with an embodiment of the present invention;

FIG. 5 is a table relating the instructions input via a user interface to the system and data codes sent by an exemplary dedicated remote control in accordance with an embodiment of the present invention;

FIG. 6 is a listing of the transmitter signal code, frequency and timing of an exemplary dedicated remote control in accordance with an embodiment of the present invention; and

FIG. 7 is a table relating the instructions input via a user interface to the system and data codes sent by an exemplary dedicated remote control in accordance with an embodiment of the present invention.

### DETAILED DESCRIPTION

“All” in the context of a dedicated remote working with all of a given manufacturer's television sets or other electronic device models is used herein to mean substantially all, with the understanding that for a given manufacturer there may exist a very small number of models of televisions or devices that the inventive dedicated remote does not work with. Nevertheless, use of the term “all” in such context does mean an overwhelming majority of the given manufacturer's television sets or other electronic device models.

Although many described embodiments of the invention primarily describe a dedicated remote control for a given manufacturer's television sets, it is understood that the same principles of the invention are applicable to other electronic devices that use remote controls, such as but not limited to, DVD players, CD players, cable television boxes, and satellite television boxes.

An embodiment of the present invention advantageously provides a dedicated remote control that features the full command set available for a given manufacturer's televisions.

Certain embodiments of the present invention advantageously provide a dedicated remote control that does not require any programming in order for it to work with all of a given manufacturer's models of televisions.

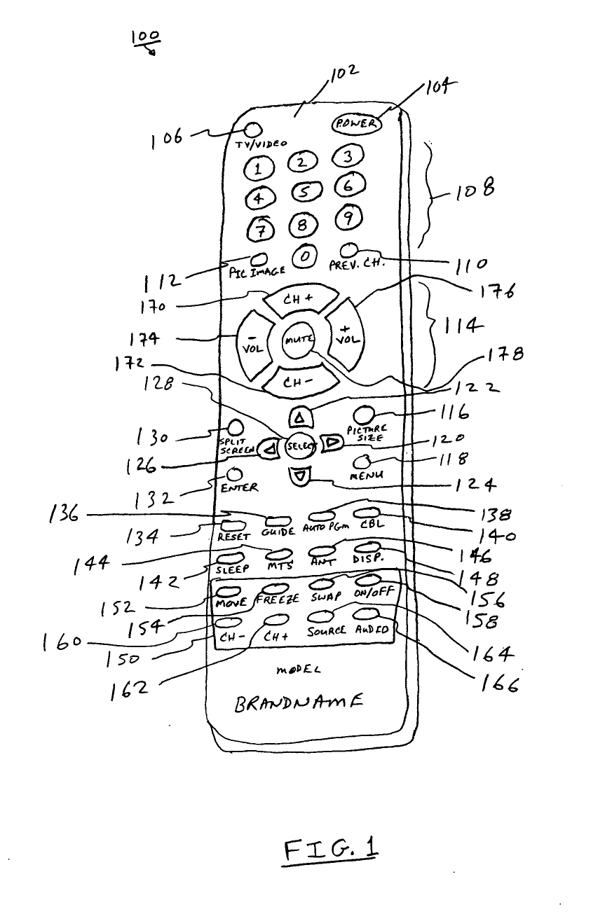

An illustration of an exemplary television remote control 100 in accordance with an embodiment of the present invention is presented in FIG. 1. In an embodiment, the dedicated remote control 100 includes a front surface 102 upon which a control interface is presented to the user. In a portion of the front surface 100, various information is preferably written, for example to aide the user in operating the control interface and to provide the user with brand name information.

In one embodiment, control buttons are provided for implementing all the features of all models of a given brand's television sets. In the exemplary embodiment of FIG. 1, these features can include: a POWER button 104, for turning the television's power on and off; a TV/VIDEO button 106, for toggling the television between television and video mode; numbered buttons 108 for input of numeric data, such as television channel selection; a PIC IMAGE button 112, for selection of video settings; a PREV. CH button 110, for selecting the last viewed channel; a typical circular button arrangement 114 for selection of channel, volume and muting, including a channel increment button 170, a channel decrement button 172, a volume increase button 176, a volume decrease button 174 and a MUTE button 178, for muting and restoring the volume; a SPLIT SCREEN button 130, for splitting the television screen into multiple panes on televisions supporting this feature; a PICTURE SIZE button 116, for changing to a wide view mode on televisions supporting this feature; a SELECT 128, up arrow 122, right arrow 120, down arrow 124, left arrow 126, and ENTER button 132, for navigation and selection of on-screen menus; a MENU button 118, for invoking an on-screen menu; a RESET button 134, to return to factory settings; a GUIDE button 136, to display programming guide for some cable and satellite receivers; a AUTO PGM button 138, for automatically programming channels; a CBL button 140, for changing to a cable from an on-air broadcast; a SLEEP button 142, for setting the turn-off timer on televisions supporting timers; an MTS button 144, for stereo and alternative language programming on televisions supporting these features; an ANT button 146 as a type of input key; a DISP button 148, for displaying channel information; and a PIP window 150, for supporting picture-in-picture (“PIP”) features in televisions supporting PIP, such features including a MOVE button 152 for moving the PIP window around the display, a FREEZE button 154 for freezing the PIP display, a SWAP button 156 for exchanging the PIP channel for the main display channel, an ON/OFF button 158 for turning PIP on and off, a CH− button 160 for decrementing the PIP channel, a CH+ button 162 for incrementing the PIP channel, a SOURCE button 164 for changing the source of the PIP channel between cable and on-air broadcast, and an AUDIO button 166 for toggling between playing the audio of the main picture and the audio of the PIP channel.

In such an embodiment, it is preferable that all the features available on a given manufacturer's entire line and all models of their television sets be provided for in the television remote control 100, thereby rendering the remote control “dedicated” to that brand of television, in the sense that it fully and completely replaces any original remote control made for any model of that brand of television.

It is possible that not all the features and controls offered on a given dedicated remote actually are supported by all the television models of the particular manufacturer. For example, using the exemplary dedicated remote of FIG. 1, above, it is possible that a television set of the supported manufacturer does not include a PIP feature, thereby rendering all the buttons of the PIP window meaningless for that particular model of television.

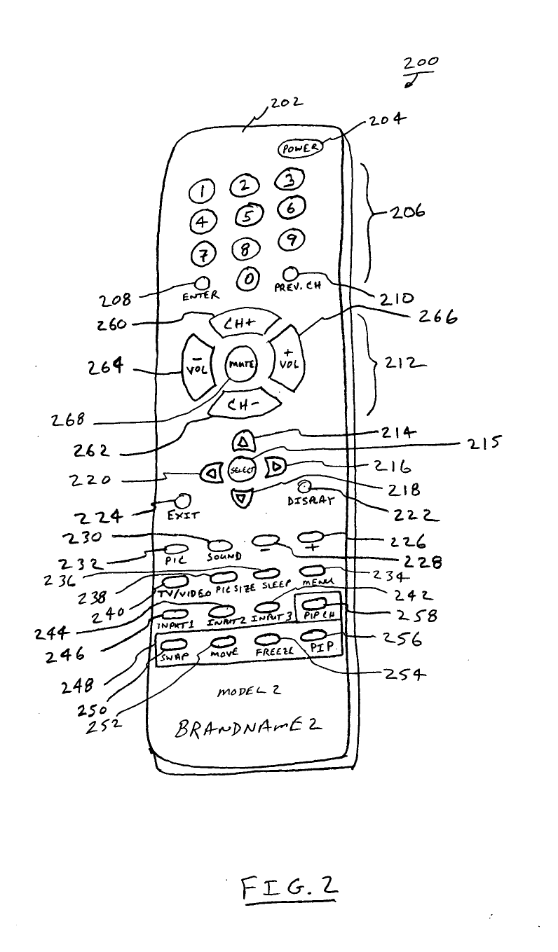

An illustration of another exemplary television remote control in accordance with an embodiment of the present invention is presented in FIG. 2. This exemplary embodiment is directed to a dedicated remote control for a different manufacturer's televisions than the embodiment of FIG. 1. In an embodiment, a different set of features are supported by televisions of the manufacturers of the embodiments supported by FIGS. 1 and 2.

For example, in the embodiment of FIG. 2, the dedicated remote control 200 includes control buttons for implementing all the features of all models of another given manufacturer's television sets. In the exemplary embodiment of FIG. 2, these features can include: a POWER button 204, for turning the television's power on and off; numbered buttons 206 for input of numeric data, such as television channel selection; an ENTER button 208, for selection of settings; a PREV. CH button 210, for selecting the last viewed channel; a typical circular button arrangement 212 for selection of channel, volume and muting, including a channel increment button 260, a channel decrement button 262, a volume increase button 266, a volume decrease button 264 and a MUTE button 268, for muting and restoring the volume; an EXIT button 224, for exiting some menu and display functions; a DISPLAY button 222, for displaying channel number and audio settings; a PIC button 232, for adjusting the video on older sets; a SELECT 215, up arrow 214, right arrow 216, down arrow 218, and left arrow button 220, for navigation and selection of on-screen menus; a SOUND button 230 for adjusting audio; a + button and a − button for increasing or decreasing video or audio, respectively; a MENU button 234, for invoking an on-screen menu; a TV/VIDEO button 240, to toggle between broadcast television and video feeds; a PIC SIZE button 238, for changing the size and shape of the picture on television models supporting this feature; a SLEEP button 236, for setting the turn-off timer on televisions supporting turn-off timers; INPUT 1, 2 and 3 buttons 246, 244, 242, for accessing DVD, Games and VCR on televisions supporting these features; and a PIP window 248, for supporting picture-in-picture (“PIP”) features in televisions supporting PIP, such features including a MOVE button 252 for moving the PIP window around the display, a FREEZE button 254 for freezing the PIP display, a SWAP button 250 for exchanging the PIP channel for the main display channel, a PIP button 256 for turning PIP on, and a PIP CH button 258 for selecting the channel for the PIP display.

In the embodiments of the invention described in FIGS. 1 and 2, it is noteworthy that the dedicated remote control in each instance allows the user access to essentially every feature of essentially every model of television by the respective television manufacturer, and yet the sets of features supported differs between the two embodiments. For example, the remote control of the embodiment described in FIG. 1 can include GUIDE 136 and AUTO PGM 138 buttons, which are missing from the remote control 200 of the embodiment of FIG. 2. For another example, the remote control 200 of the embodiment described in FIG. 2 can include INPUT 1, 2 and 3 buttons 246, 244, 242, which are missing from the remote control 100 of the embodiment of FIG. 1.

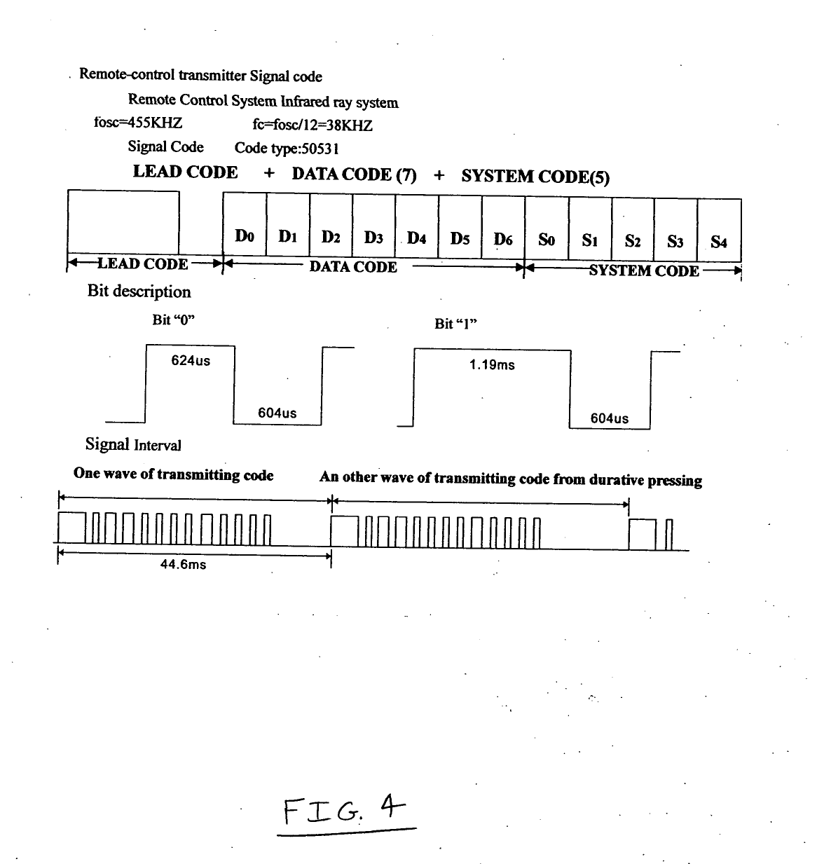

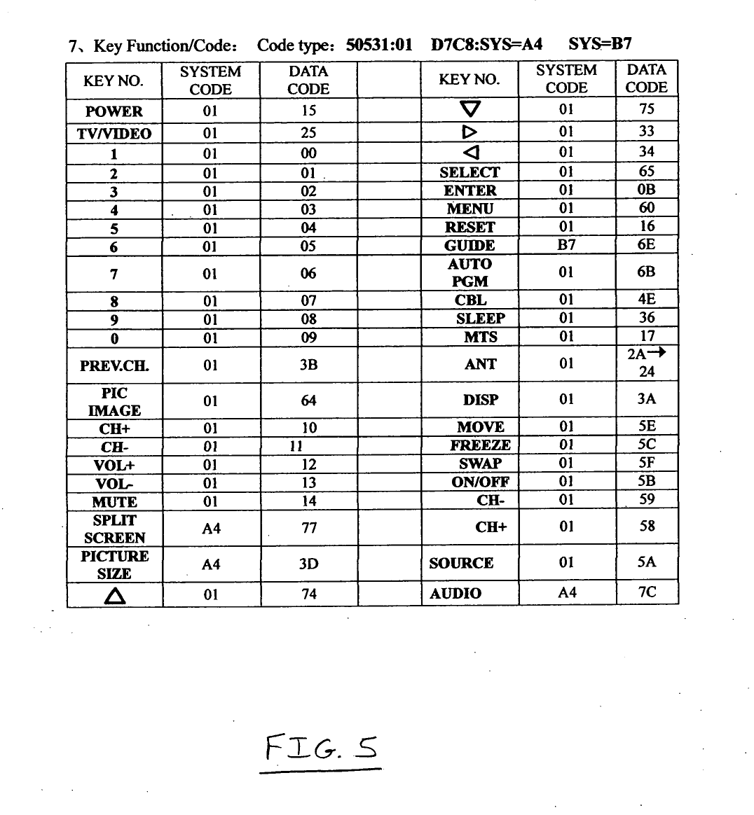

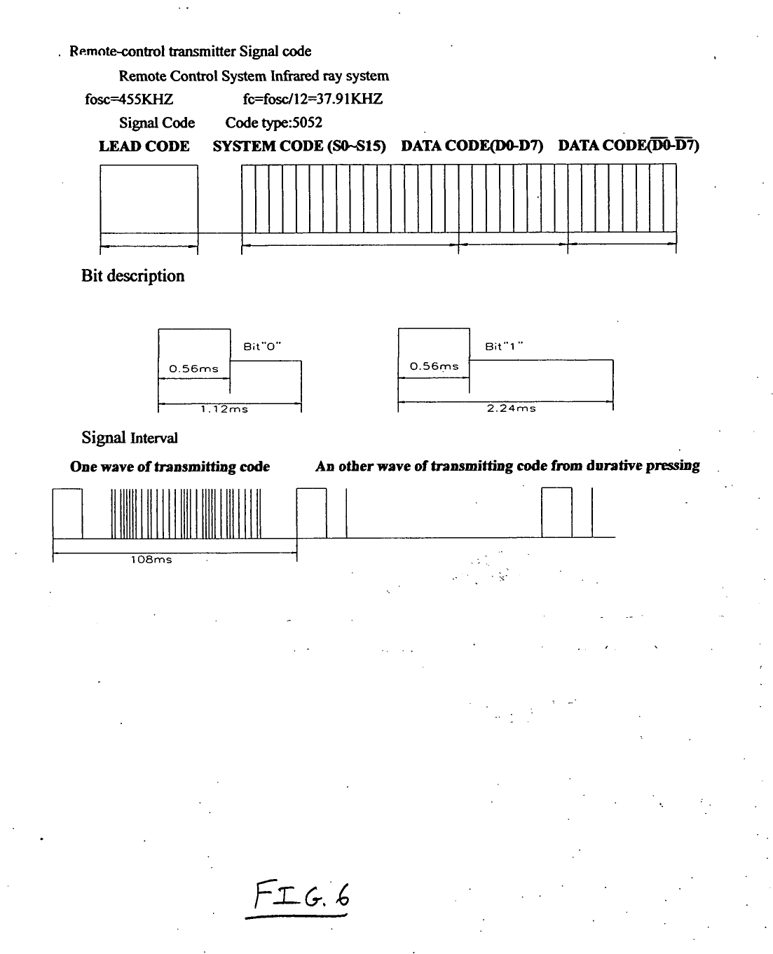

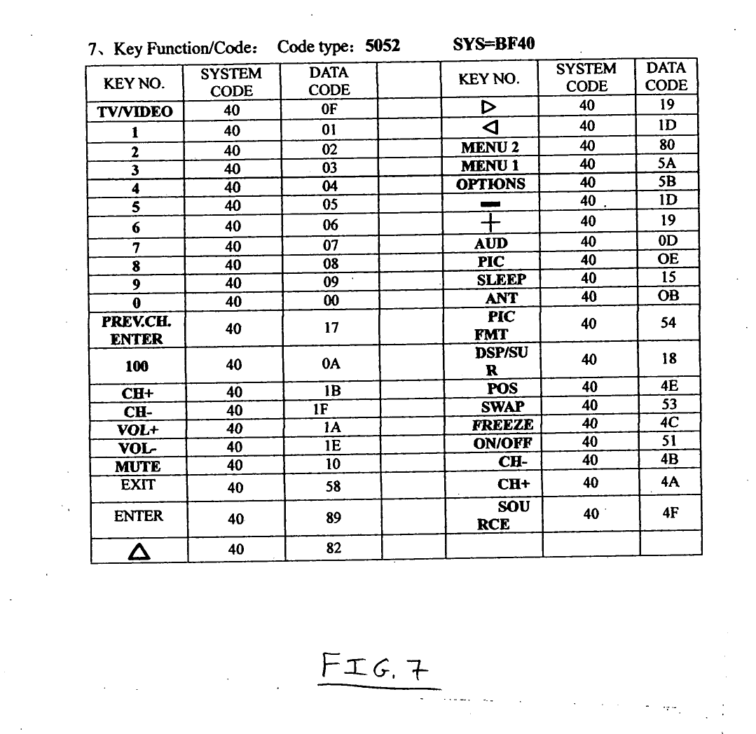

In an embodiment, the dedicated remote control of the present invention is made by examining most or all models of a given manufacturer's television sets to determine the remote control transmission frequency and command sets they support. This frequency and command set information are used to configure the remote control unit, having at least a user interface in communication with a processor and associated memory, and a transmitter controlled by the processor for sending remote control commands to television sets. The remote control unit so configured is then a dedicated remote control unit for the given manufacturer's television sets. Examples of dedicated remote control specifications, including key function codes and timing diagrams are provided in FIGS. 4-7. The remote control specifications whose function codes and timing diagrams are provided in FIGS. 4-7 incorporate a custom integrated circuit (“IC”) for interfacing to the user interface and the transmitter. In the depicted embodiments, this custom IC instructs the transmitter to transmit the control signals as indicated in the descriptions of FIGS. 4 and 6. For example, each of the devices of FIG. 4 and 6 employ a three part code word consisting of lead code, data code and system code bits, with the values of the lead, data and system code bits determined by the tables in FIGS. 5 and 7, respectively.

In more detail, FIG. 4 depicts the transmitter signal code, frequency and timing of an embodiment of the dedicated remote control of the present invention. In this embodiment, the dedicated remote control employs a standard infrared ray system operating at the listed frequencies of 455 KHZ (fosc) and 38 KHZ (fc). A table indicating the system and data codes sent for each key or button of the user interface of an embodiment of the dedicated remote is provided in FIG. 5. For example, when the user presses the “TV/VIDEO” button, the system code is 01 and the data code is 25, as provided in the first column of the table of FIG. 5, and these are sent from the transmitter in the dedicated remote to the television set. In a preferred embodiment, a table such as presented in FIG. 5 is stored in non-volatile memory associated with the processor of the dedicated remote, together with the signal frequency and timing information, such as presented in FIG. 4. Upon use, the processor then determines what system and data codes to send at the stored frequency in accordance with the stored timing information and instructs the transmitter to send the necessary signals.

Similarly, FIG. 6 depicts the transmitter signal code, frequency and timing, and FIG. 7 depicts a table indicating the system and data codes sent for each key or button of the user interface of another embodiment of the dedicated remote. Note that both the frequencies and system/data codes of the embodiment represented by FIGS. 6 and 7 differ substantially from those of the embodiment of the invention represented by FIGS. 4 and 5. For example, as indicated in FIG. 6, the frequencies for the command set of the FIG. 6/7 embodiment is 455 KHZ (fosc) and 37.91 KHZ (fc), versus 38 KHZ (fc) for the FIGS. 4/5 embodiment, and the “TV/VIDEO” system and data codes are 40 and 0x0f, respectively, versus 01 and 25 for the FIGS. 4/5 embodiment. Although the invention may require a different set of frequency, timing, system and data codes for each embodiment, with each embodiment operating with a different manufacturer's television sets, it is understood that there may be instances in which a given set of these parameters may successfully operate more than one manufacturer's television sets. This in no way distracts from the objects of the invention.

Although described herein primarily with respect to television sets, it will be apparent to those of ordinary skill in the electronic arts that the present invention is applicable to any electronic devices that use a remote control. Examples of such devices include but are not limited to stereo systems, video game systems, alarm system, and others.

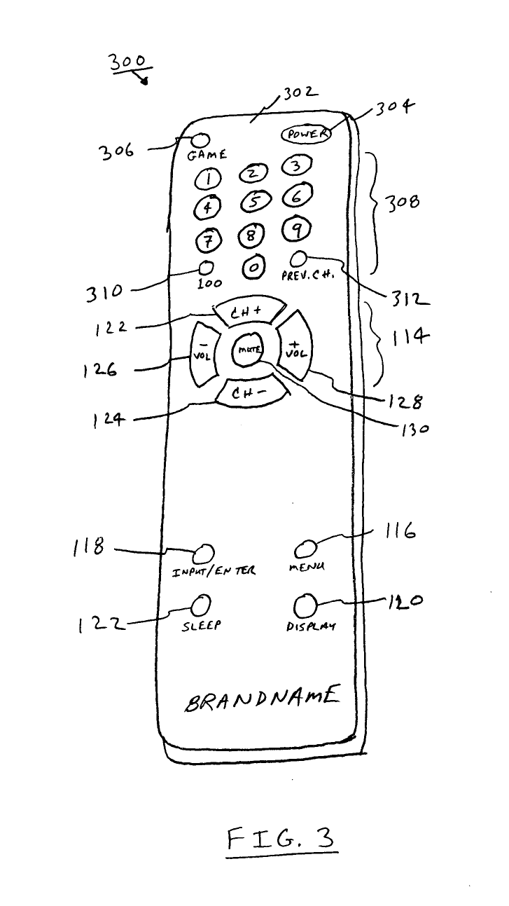

An illustration of an exemplary dedicated remote control for an electronic game system is presented in FIG. 3. In an embodiment, a dedicated remote control for an electronic game system 300 includes a face 302 having buttons and writing for the user. In an embodiment, the buttons include a POWER button 304 for turning the game system on and off; a GAME button 306, for accessing game mode; numbered buttons 0-9 for input of numeric data 308, a 100 button 310, for input of numbers over 99; a PREV. CH button 312, for selecting the last viewed channel; a typical circular button arrangement 114 for selection of channel, volume and muting, including a channel increment button 122, a channel decrement button 124, a volume increase button 128, a volume decrease button 126, and a MUTE button 130, for muting and restoring the volume; an INPUT/ENTER button 118, for DVD and VCR input on game systems supporting this feature; a MENU button 116, for all setup including audio, video and channel auto programming; a SLEEP button 122, for programming a sleep timer on game systems supporting this feature; and a DISPLAY button 120, for showing channel information.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A remote control device for use with substantially all models of a manufacturer's media devices, comprising:
a case;
a communication interface disposed in said case through which control instructions are issued;
a remote control signal transmitter; and
a processor operating under the control of program code to perform the steps of:
converting the control instructions received from the communications interface into one or more remote control signals; and
directing the remote control signal transmitter to transmit the one or more remote control signals at a pre-selected frequency, said pre-selected frequency and said one or more remote control signals corresponding to the frequency and remote control signals to which substantially all models of the manufacturer's media devices respond.

2. The remote control device according to claim 1, the media device being a television.

3. The remote control device according to claim 1, the media device being a DVD player.

4. The remote control device according to claim 1, the media device being a CD player.

5. The remote control device according to claim 1, the media device being a cable television box.

6. The remote control device according to claim 1, the media device being a satellite television box.

7. The remote control device according to claim 1, the manufacturer's media device response being to perform a function indicated by the control instructions.

8. A system for remotely controlling substantially all models of a given manufacturer's electronic devices, said system comprising:
an electronic device to be remotely controlled, said device having a receiver for receiving one or more transmitted remote control signals, said device being further configured to be controlled based on the received remote control signals; and
a remote control unit, said unit comprising a processor operatively connected to a memory, a command input interface, and a transmitter capable of transmitting at a pre-selected communication frequency, said processor and memory configured for:
accepting an input from the command input interface;
converting said input into one or more remote control instructions for said electronic device; and
transmitting by the transmitter the one or more remote control instructions at the communication frequency;
wherein said pre-selected communication frequency and one or more remote control instructions are pre-selected to work for substantially all models of a given manufacturer's electronic devices.

9. The system according to claim 8, the electronic device being a television.

10. The system according to claim 8, the electronic device being a DVD player.

11. The system according to claim 8, the electronic device being a CD player.

12. The system according to claim 8, the electronic device being a cable television box.

13. The system according to claim 8, the electronic device being a satellite television box.

14. A method of remotely controlling substantially all models of a given manufacturer's electronic devices, said method comprising:
determining a communication frequency and a set of remote control signals to which substantially all of the manufacturer's electronic devices respond to remotely;
providing a processor operatively connected to a memory, an input device and a transmitter capable of transmitting at the communication frequency, said processor and memory configured to run a computer software, said software operative for:
accepting an input from the input device;
converting said input into one or more remote control instructions for said electronic devices; and
transmitting by the transmitter the one or more remote control instructions at the communication frequency.

15. The method according to claim 14, the electronic devices being televisions.

16. The method according to claim 14, the electronic devices being DVD players.

17. The method according to claim 14, the electronic devices being CD players.

18. The method according to claim 14, the electronic devices being cable television boxes.

19. The method according to claim 14, the electronic devices being satellite television boxes.
